(19) United States
(12) Patent Application Publication
(10) Pub. No.: US 2024/0072488 A1
(43) Pub. Date: Feb. 29, 2024

(54) Socket Structure

(71) Applicant: Dongguan Wontravel Electric Co.,Ltd., Dongguan (CN)

(72) Inventors: LIANGGUAN LIN, Dongguan (CN); XIAOLONG LI, Dongguan (CN); JUNWEN XIONG, Dongguan (CN)

(21) Appl. No.: 18/503,427

(22) Filed: Nov. 7, 2023

Related U.S. Application Data
(63) Continuation of application No. PCT/CN2021/136665, filed on Dec. 9, 2021.

(30) Foreign Application Priority Data
May 9, 2021 (CN) 202120980917.8

(51) Int. Cl. H01R 13/58; H01R 24/20

(52) U.S. Cl. CPC H01R 13/58; H01R 24/20

(57) ABSTRACT

The present invention discloses a socket structure, including a shell having a chamber, a bracket in the chamber that is provided with a cavity to accommodate conductive sheet component, and a conductive wire that passes through the shell and bracket in turn, extends into the cavity, and is electrically connected to the conductive sheet component, the conductive wire is clamped and fixed on the bracket; the arrangement reduces the need for the conductive wires to be fixed by wire clamps, decreases the volume of the socket, and the integration between the bracket and the charging PCB board component provides a multifunctional product combination with charging function on the socket, which is easy to install and has a small volume; in further, the soft tail card which can be detachably installed effectively reduces the production costs while effectively ensuring the safe swing testing of socket wires.

### CROSS-REFERENCE TO RELATED APPLICATIONS

The present application is a U. S. continuation of co-pending International Patent Application No. PCT/CN2021/136665 filed Dec. 9, 2021, which claims foreign priority of Chinese Patent Application No. 202120980917.8, filed on May 9, 2021 in the State Intellectual Property Office of China, the contents of all of which are hereby incorporated by reference.

### TECHNICAL FIELD

The present invention relates to the field of socket technology, in particular to a socket structure.

### BACKGROUND

Wired sockets, common household items, facilitate the charging or power connection of electrical or electronic devices, avoiding the problem of inconvenient use of fixed sockets. Existing wired sockets generally have large size, making them inconvenient to carry and use, and a socket with reduced volume, however, is prone to the influence of the safety or safety testing on the socket wires. Existing wired sockets, in general, include a shell and a conductive sheet component, with a through hole on one side of the shell for the conductive wire to pass through. Wire clamp nuts are provided at the position of shell adjacent to the through hole to prevent the conductive wire from pulling or swinging during use, which in turn affects the service life of conductive wires or makes the wires fail to pass pulling tests concerning pulling. For this reason, the current wired sockets available in the market, which are generally large in size, seriously affect its portability because of the absence of compact structure.

### SUMMARY

The main purpose of the present invention is to propose a socket structure that facilitates use and handling because of reduced volume, while also ensuring its safety performance, as well as compact structure and simple installation.

To achieve the above objectives, the present invention proposes a socket structure, including a shell having a chamber, a bracket in the chamber that is provided with a cavity to accommodate conductive sheet component, and a conductive wire that passes through the shell and bracket in turn, extends into the cavity, and is electrically connected to the conductive sheet component, and the conductive wire is clamped and fixed on the bracket.

Preferably, the bracket includes an upper bracket and a lower bracket, both are provided with a first positioning part and a second positioning part; the first positioning part and the second positioning part form a clamping hole, and the conductive wire passes through the clamping hole and is clamped between the first positioning part and the second positioning part.

Preferably, the diameter of the clamping hole is smaller than that of the conducting wire.

Preferably, the shell includes a housing having an opening at one end, and a cover body that is installed at the opening, and the bracket is placed in the housing chamber through the opening and fixed through the cover body.

Preferably, the cover body is provided with a soft tail card having a through hole for conducting wires to pass through, and the soft tail card is integrally formed with the cover body or can be detachably installed.

Preferably, the cover body has a pivot hole, and the soft tail card can be pivotally installed on the pivot hole and clamped to the side wall of the cover body.

Preferably, the soft tail card includes a tube body, a first positioning seat and a second positioning seat that are disposed on the tube body, a positioning groove which is formed between the first positioning seat and the second positioning seat fits the side wall, the first positioning seat can pass through the pivot hole, the second positioning seat is limited to the side wall of the cover body, and the positioning groove can pivot along the side wall.

Preferably, the side of the bracket opposite to the cover body has a limit groove that fits the first positioning seat, and the first positioning seat can be clamped inside the limit groove.

Preferably, the bracket extends outward with at least one limit convex block, and the housing has a step groove that fits the limit convex block.

Preferably, the bracket extends backwards with a positioning cavity, and is provided with an electrical hole.

Preferably, a clearance fit exists between the inner wall of the housing and the outer wall of the bracket, the housing has a convex card part, the cover body has a concave groove part that fits the convex card part, and the step groove is disposed on the convex card part, when the cover body and the shell fit, the cover body can fix the limit convex block between the cover body and the housing.

Preferably, the clamping hole is trapezoidal or extends inward with longitudinal and/or transverse clamping strips.

In the technical solution of the present invention, the conductive wire is clamped and fixed on a bracket (i.e. the bracket can clamp and fix the conductive wire without leaving another position, as in the prior art, to fix the conductive wire through a wire card), so that the solution reduces the overall volume of the socket, decreases the installation space of the conductive wire in the socket housing, and can pass the safety regulations such as wire pulling. Meanwhile, the integration between the bracket and the charging PCB board component provides a multifunctional product combination with charging function on the socket, which is easy to install and has a small volume. Through the detachable installation of a soft tail card, it effectively ensures the safe swing test of the socket through the conductive wire and can effectively reduce production costs. In further, the soft tail card which can be detachably installed effectively reduces the production costs while effectively ensuring the safe swing testing of socket wires.

### BRIEF DESCRIPTION OF DRAWINGS

FIG. 1 is an exploded view of the present invention;

FIG. 2 is the second exploded view of the present invention;

FIG. 3 is a three-dimensional schematic diagram of the present invention.

FIG. 4 is a cross-sectional view (three-dimensional) of the present invention;

FIG. 5 is a schematic diagram of the cross-sectional view of the present invention with hidden cover body;

FIG. 6 is a schematic diagram of the first and second embodiments of the bracket;

FIG. 7 is an enlarged schematic diagram of the second positioning part.

In the figure, 1 is the bracket, 11 is the upper bracket, 12 is the lower bracket, 2 is the card hole, 21 is the first positioning part, 22 is the second positioning part, 3 is the shell, 31 is the opening, 4 is the cover body, 41 is the pivot hole, 5 is the soft tail card, 50 is the through hole, 51 is the tube body, 52 is the first positioning seat, 53 is the second positioning seat, 54 is the positioning slot, 61 is the first slot, 62 is the slot through hole, 71 is the limit convex block, 72 is the step slot, 81 is the charging PCB board component, 82 is the connector, 91 is the limit slot, 92 is the positioning cavity, 93 is the electrical hole, 100 is the conductive wire, 200 is the conductive sheet component, and 201 is the sharp part.

### DETAILED DESCRIPTION

The technical solutions in the embodiments of the present invention will be described clearly and completely in conjunction with the accompanying drawings of the embodiments of the present invention. Obviously, the described embodiments are only a part of the embodiments of the present invention, rather than all the embodiments. Based on the embodiments of the present invention, all other embodiments obtained by those of ordinary skill in the art without creative work shall fall within the protection scope of the invention.

It should be noted that directional indications (such as up, down, left, right, front, back, top, bottom, inside, outside, vertical, horizontal, longitudinal, counterclockwise, clockwise, circumferential, radial, axial . . . ) involved in the embodiments of the present invention, if any, are only used to explain the relative position relationship and motion between components in a specific posture (as shown in the attached figure). The directional indications also change accordingly if the specific posture changes.

In addition, the terms like “first” and “second” are only for illustrative purposes and cannot be understood as indicating or implying relative importance or the number of technical features referred to. Therefore, the features defined with “first” and “second” may explicitly or implicitly include at least one or a plurality of features. In further, the technical solutions between embodiments can be combined with each other, but must be based on what person of ordinary skill in the art can achieve. The combination of the technical solutions should be considered not exist and not within the scope of protection required by the present invention when such combination of technical solutions conflicts or cannot be realized.

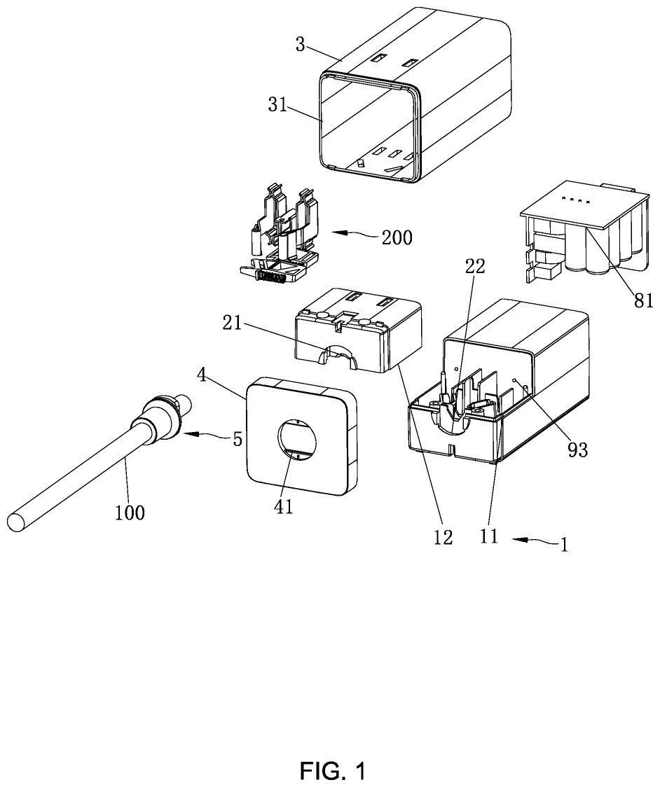

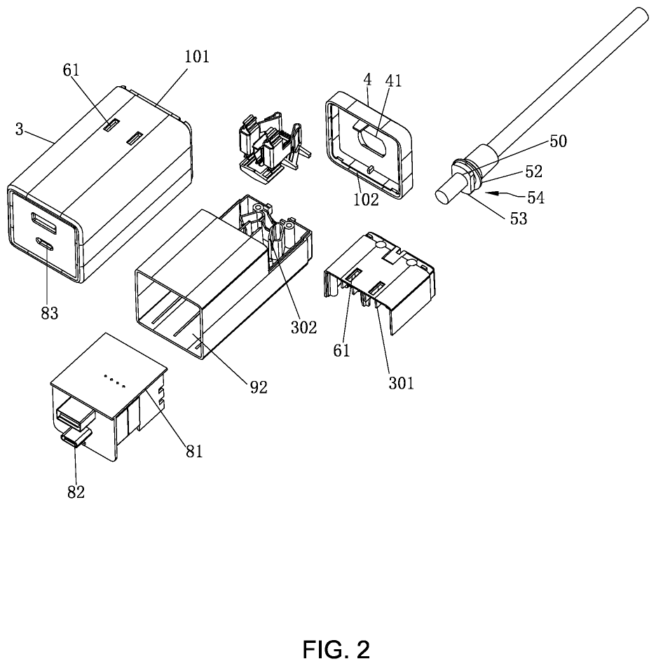

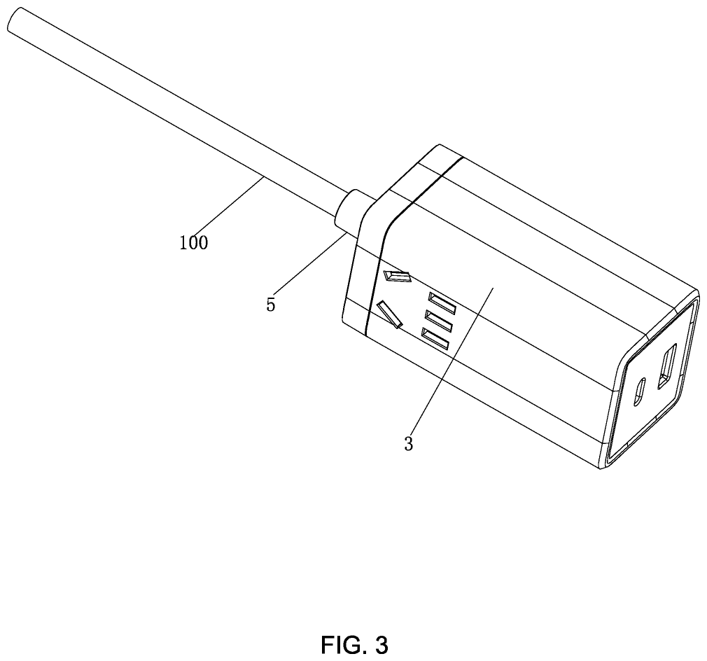

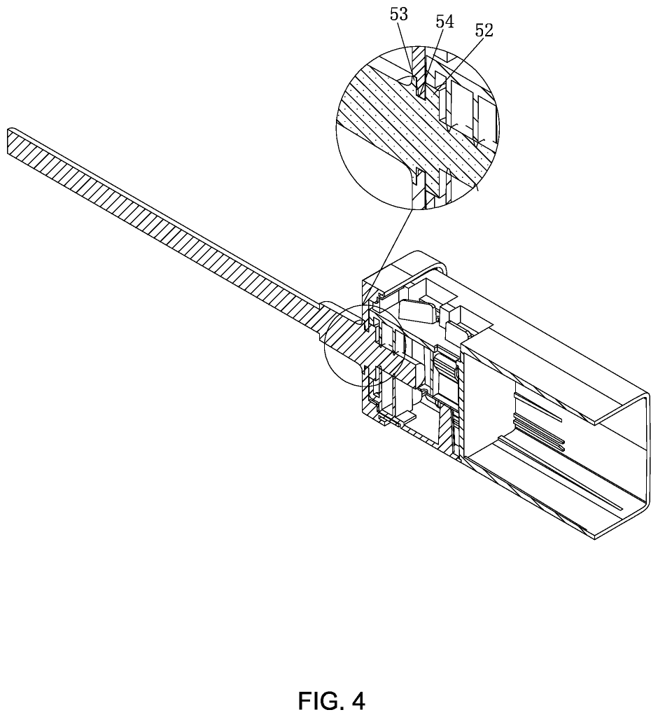

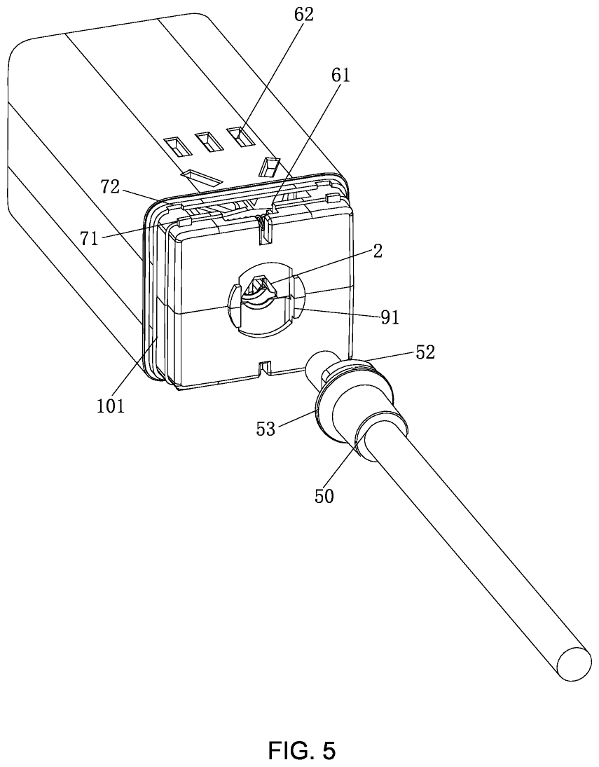

As shown in FIG. 1 to FIG. 7, a socket structure, including bracket 1 having a chamber to accommodate the conductive sheet component 200, the bracket 1 includes an upper bracket 11 and a lower bracket 12, at least one side of the upper bracket 11 and/or the lower bracket 12 is provided with a first slot 61. Both the upper bracket 11 and the lower bracket 12 are provided with a first positioning part 21 and a second positioning part 22; the first positioning part 21 and the second positioning part 22 form a clamping hole 2, and the conductive wire 100 passes through the clamping hole 2 and is clamped between the first positioning part 21 and the second positioning part 22.

A clamping hole 2 is formed between the upper bracket 11 and the lower bracket 12, when the conductive wire 100 passes through the clamping hole 2, the first positioning part 21 and the second positioning part 22 clamp and fix the conductive wire 100 onto the bracket 1 (that is, the bracket 1 can already clamp and fix the conductive wire 100 without leaving another position to fix the conductive wire with a wire card), thereby reducing the volume of socket 1 (namely the fixed installation space of the conductive wire 100 inside the socket housing), in further, the direct or indirect connection between the conductive sheet component 200 in bracket 1 and the charging PCB board component 81 provides a multi-functional product combination for charging on the socket, which is easy to install and small in volume; the soft tail card 5 that can be detachably installed effectively ensures the conductive wire 100 that the socket allows to pass through passes the safety testing such as safety swinging.

In the first embodiment of the present invention, the upper bracket 11 and the lower bracket 12 are provided with a first positioning part 21 and a second positioning part 22, respectively; the first positioning part 21 and the second positioning part 22 form a clamping hole 2, the conductive wire 100 is clamped between the first positioning part 21 and the second positioning part 22, and is also clamped by the first positioning part 21 and the second positioning part 22. At least one group of first positioning part 21 and second positioning part 22 is provided and in the embodiment of the present invention, two groups of the first positioning part 21 and second positioning part 22 are provided to better clamp the conductive wire 100 and prevent it from being pulled.

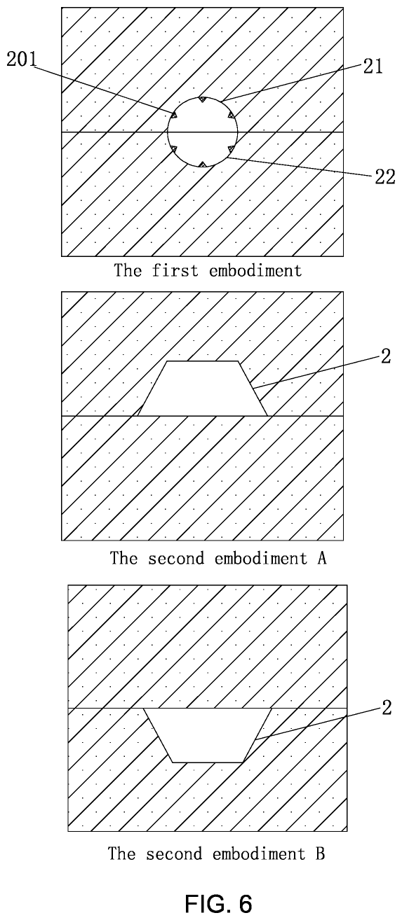

In the second embodiment of the present invention, as shown in FIG. 6, the clamping hole 2 is disposed on the side of the lower bracket 12 opposite the upper bracket 11 or on the side of the upper bracket 11 opposite the lower bracket 12, and when the conductive wire 100 is placed on the clamping hole 2, the upper bracket 11 and lower bracket 12 will clamp and fix the conductive wire 100 on the bracket 1, and the upper bracket 11 and lower bracket 12 can be fixed by various existing fixing methods.

The diameter of clamping hole 2 is smaller than that of conductive wire 100, and clamping hole 2 can be in regular or irregular shapes such as trapezoidal, triangular, or circular shape, etc; In order to avoid displacement of conductive wire 100, in the preferred embodiment, a certain sharp part 201 can be arranged around the clamping hole 2, so that the sharp part 201 is partially clipped into the protective layer of conductive wire 100.

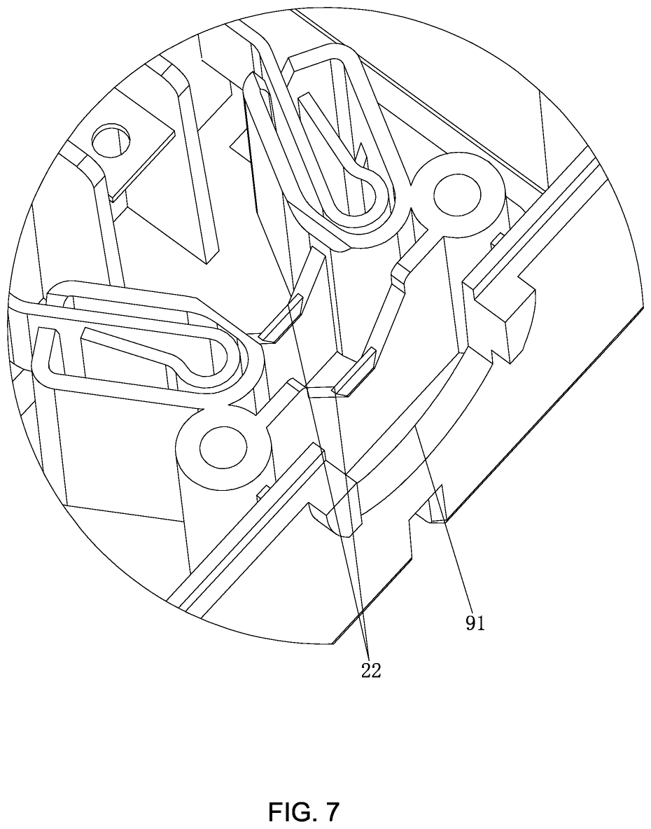

In the embodiment of the present invention, the first slot 61 is disposed on the lower bracket 12 and/or upper bracket 11, a plurality of first slots 61 can be provided to dock other electronic products while facilitating charging. In the embodiment of the present invention, as shown in FIG. 7, two first slots 61 are provided and they are disposed opposite to each other.

In the embodiment of the present invention, the shell includes a housing 3 having an opening 31 at one end, and the opening 31 is installed with a cover body 4, the bracket 1 is placed in the cavity of the housing 3 through the opening 31 and fixed by the cover body 4; the housing 3 has a slot through hole 62 that fits the first slot 61, and the opening 31 which is generally disposed at the rear end of the housing 3, of course, can also be disposed at the side end of the housing 3, i.e. changing the position of the conductive wire 100.

In further, the cover body 4 has a soft tail card 5 (generally made of soft material) that provides a through hole 50 for the conductive wire 100 to pass through. The soft tail card 5 is integrally formed with the cover body 4, or can be detachably installed, and the soft tail card 5 having a certain degree of deformation can facilitate its transition fit with the soft conductive wire 100 and reduce the friction damage to the conductive wire 100 at the position. Depending on the different production and usage requirements, the soft tail card 5 and the cover body 4 are integrally formed or detachably installed. The cover body 4 and the soft tail card 5, which are generally made of two different materials, can be integrally formed through injection molding. To save production costs, the cover body 4 and the tail card 5 can be manufactured separately by injection molding before being assembled for use.

Specifically, the cover body 4 has a pivot hole 41, the soft tail card 5 can be pivotally installed in the pivot hole 41 and snapped onto the side wall of the cover body 4, that is, the soft tail card 5 is pivotally installed and snapped onto the cover body 4, thus facilitating installation and reducing production costs. The soft tail card 5 can be locked after pivoting by a locking structure disposed in the pivot hole 41, or fixed through ultrasonic welding or by glue.

In the embodiment of the present invention, the soft tail card 5 includes a tube body 51, a first positioning seat 52 and a second positioning seat 53 that are arranged on the tube body 51, a positioning groove 54 that fits the side wall is formed between the first positioning seat 52 and the second positioning seat 53. The first positioning seat 52 can pass through the pivot hole 41, the second positioning seat 53 is limited to the side wall of the cover body 4, and the positioning groove 54 can pivot along the side wall of the cover body 4, that is, the second positioning seat 53 having larger diameter and area than the pivot hole 41 is limited (in the embodiment of the present invention, the second positioning seat 53 is in a circular shape, and the first positioning seat 52 and pivot hole 41 are in a strip shape). Of course, the first positioning seat 52, the second positioning seat 53, and the pivot hole 41 in other shapes can also pivot the soft tail card 5.

The clearance fit generally between the soft tail card 5 and the conductive wire 100 can allow the conductive wire 100 pass through and maintain a certain degree of water resistance (additional glue injection can also be performed).

In the embodiment of the present invention, a limit groove 91 that fits the first positioning seat 52 is provided on the side of the bracket 1 opposite the cover body 4, so that the first positioning seat 52 is snapped into and fixed in the limit groove 91 to prevent the soft tail card 51 from rotating, ensuring stability during the pull test, and convenient installation and fixation.

In the embodiment of the present invention, the bracket 1 extends outward with at least one limit convex block 71, and the housing 3 is provided with a step groove 72 that fits the limit convex block 71. The coordination between the limit convex block 71 and the step groove 72 facilitates the installation and fixation of bracket 1. Fixing the cover body 4 on the housing 3, that is, fixing the limit convex block 71, can effectively ensure the tightening force of the socket product.

In the embodiment of the present invention, a charging PCB board component 81 having a connector 82 is provided between the cavity of the shell 3 and the bracket 1, and the shell 3 has a second slot 83 that fits the connector 82, and the second slot 83 is a universal mobile power interface such as USB \TYPE-C.

Specifically, bracket 1 extends backwards with a positioning cavity 92, bracket 1 has an electrical hole 93, and the charging PCB board 81 is placed inside the positioning cavity 92. In practical use, the charging PCB board component 81 has a connector (such as a conductive wire or pin) that passes through the gelectrical hole 93 and is then connected to the electrical phase of the socket for easy assembly. Meanwhile, the arrangement of positioning cavity 92 can facilitate the injection of cooling silicone around the charging PCB board component 81, ensuring heat dissipation and conduction. In further, the positioning cavity 92 can make the product more stable as a whole, and allow for the injected cooling silicone in a more regular shape.

In the embodiment of the present invention, a clearance fit exists between the inner wall of the shell 3 and the outer wall of the bracket 1, the shell 3 has a convex card part 101, and the cover body 4 has a concave groove part 102 that fits the convex card portion 101. The step groove 72 is disposed on the convex card part 101, and when the cover 4 and the shell 3 fit, the cover body 4 can fix the limit convex block 71 between the cover 4 and the shell 3. The coordination between the convex clamping part 101 and the concave groove part 102 facilitates the fixation of bracket, while the clearance fit between the bracket 1 and the shell 3 can ensure the stable internal structure of the socket even in the event of abnormal use (such as falling or collision).

In the embodiment of the present invention, the clamping hole 2 is in trapezoidal shape or the clamping hole extends inward with longitudinal and/or transverse clamping strips 201.

In addition, the above are only preferred embodiments of the present application that are not intended to limit the application. Any modifications, equivalent substitutions, and improvements made within the spirit and principles of the present application shall be included in the scope of protection of the present application.

What is claimed is:

1. A socket structure, wherein it includes a shell having a chamber, a bracket in the chamber that is provided with a cavity to accommodate conductive sheet component, and a conductive wire that passes through the shell and bracket in turn, extends into the cavity, and is electrically connected to the conductive sheet component, and the conductive wire is clamped and fixed on the bracket.

2. The socket structure according to claim 1, wherein the bracket includes an upper bracket and a lower bracket, both are provided with a first positioning part and a second positioning part; the first positioning part and the second positioning part form a clamping hole, and the conductive wire passes through the clamping hole and is clamped between the first positioning part and the second positioning part.

3. The socket structure according to claim 2, wherein the diameter of the clamping hole is smaller than that of the conducting wire.

4. The socket structure according to claim 1, wherein the shell includes a housing having an opening at one end, and a cover body that is installed at the opening, and the bracket is placed in the housing chamber through the opening and fixed through the cover body.

5. The socket structure according to claim 4, wherein the cover body is provided with a soft tail card having a through hole for conducting wires to pass through, and the soft tail card is integrally formed with the cover body or can be detachably installed.

6. The socket structure according to claim 5, wherein the cover body has a pivot hole, and the soft tail card can be pivotally installed on the pivot hole and clamped to the side wall of the cover body.

7. The socket structure according to claim 6, wherein the soft tail card includes a tube body, a first positioning seat and a second positioning seat that are disposed on the tube body, a positioning groove which is formed between the first positioning seat and the second positioning seat fits the side wall, the first positioning seat can pass through the pivot hole, the second positioning seat is limited to the side wall of the cover body, and the positioning groove can pivot along the side wall.

8. The socket structure according to claim 2, wherein the side of the bracket opposite to the cover body has a limit groove that fits the first positioning seat, and the first positioning seat can be clamped inside the limit groove.

9. The socket structure according to claim 1, wherein the bracket extends outward with at least one limit convex block, and the housing has a step groove that fits the limit convex block.

10. The socket structure according to claim 1, wherein the bracket extends backwards with a positioning cavity, and is provided with an electrical hole.

11. The socket structure according to claim 9, wherein a clearance fit exists between the inner wall of the housing and the outer wall of the bracket, the housing has a convex card part, the cover body has a concave groove part that fits the convex card part, and the step groove is disposed on the convex card part, when the cover body and the shell fit, the cover body can fix the limit convex block between the cover body and the housing.

12. The socket structure according to claim 2, wherein the clamping hole is trapezoidal or extends inward with longitudinal and/or transverse clamping strips.
